(19) United States
(12) Patent Application Publication
(10) Pub. No.: US 2006/0267426 A1
(43) Pub. Date: Nov. 30, 2006

(54) Induction Motor with Ratchet Device

(75) Inventors: Toshio Maehara, Gunma (JP); Eiji Kuroda, Gunma (JP)

Correspondence Address: BOYLE FREDRICKSON NEWHOLM STEIN & GRATZ, S.C., 250 E. WISCONSIN AVENUE, SUITE 1030, MILWAUKEE, WI, 53202, US

(73) Assignee: Japan Servo Co., Ltd., Tokyo (JP)

(21) Appl. No.: 11/420,842

(22) Filed: May 30, 2006

(30) Foreign Application Priority Data
May 31, 2005 (JP) 159036/2005

(51) Int. Cl. H02K 7/06; H02K 37/14

(52) U.S. Cl. 310/78; 310/49 R; 310/37

(57) ABSTRACT

An induction motor has a gear connected to an output shaft of the motor, a ratchet wheel having a claw for preventing the reverse rotation of the gear, and an urging device. The urging device urges the ratchet wheel so that an end surface of a tip end of the claw of the ratchet wheel is brought into contact with a tooth face facing a reverse rotary direction of the gear so as to prevent the reverse rotation of the gear. A contact angle formed by the end surface of the tip end of the claw and a center line of the tooth of the end surface of gear preferably is set equal to a pressure angle of the gear.

### BACKGROUND OF THE INVENTION

1. Field of the Invention

The present invention relates to an induction motor with a ratchet device, and more particularly, relates to an induction motor with a ratchet device for use in an automatic ice making apparatus or the like.

2. Description of the Prior Art

An AC-drive single-phase hysteresis motor is normally used for an automatic ice making apparatus. In such hysteresis motor, the output efficiency is very low, and is about 1˜2%, so that the size of the motor cannot be small, and that the manufacturing cost of the motor cannot be reduced.

An AC-drive single-phase induction motor is also known. Such motor has a high efficiency of about ten times larger than that of the hysteresis motor and accordingly the size and the manufacturing cost thereof can be reduced, however, it is liable to rotate in the reverse direction because of the single-phase motor.

Japanese Patent Application Laid-Open No. 198639/91 discloses a reverse rotation preventive structure comprising a leaf spring or a reverse rotation preventive lever supported with a friction by a shaft of a gear.

However, such structure is very complicated.

### SUMMARY OF THE INVENTION

An object of the present invention is to solve the above problem.

Another object of the present invention is to provide an induction motor with a ratchet device comprising an induction motor, a gear connected to an output shaft of the motor, a ratchet wheel having a claw for preventing the reverse rotation of the gear, and an urging device for urging the ratchet wheel so that an end surface of a tip end of the claw of the ratchet wheel is brought into contact with a tooth face facing a reverse rotary direction of the gear so as to prevent the reverse rotation of the gear.

Still another object of the present invention is to provide the induction motor wherein a contact angle formed by the end surface of the tip end of the claw and a center line of a tooth of the gear contacting with the end surface of the tip end of the claw is set equal to a pressure angle of the gear.

A further object of the present invention is to provide the induction motor wherein an inside corner of the end surface of the tip end of the claw is projected toward a tooth root of the gear so that the end surface of the tip end of the claw is not removed from the tooth face of the gear when the gear is rotated reversely.

These and other aspects and objects of the present invention will be better appreciated and understood when considered in conjunction with the following description and the accompanying drawings. It should be understood, however, that the following description, while indicating preferred embodiments of the present invention, is given by way of illustration and not of limitation. Many changes and modifications may be made within the scope of the present invention without departing from the spirit thereof, and the invention includes all such modifications.

### BRIEF DESCRIPTION OF THE DRAWINGS

FIG. 1 is a vertically sectional view of an induction motor with a ratchet device according to the present invention, and

FIG. 2 is an enlarged view of the ratchet device shown in FIG. 1.

FIG. 3 is an enlarged view of a ratchet device according to the other embodiment of the present invention.

### DESCRIPTION OF THE PREFERRED EMBODIMENTS

The present invention will now be explained with reference to the drawings.

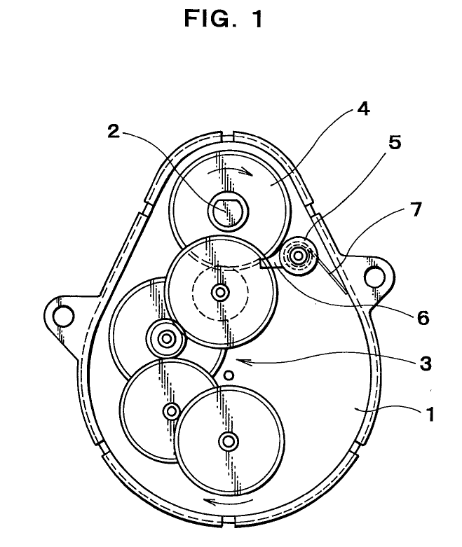

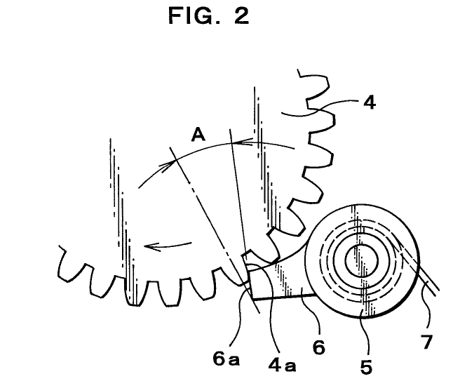

An induction motor with a ratchet device of the present invention, as shown in FIG. 1 and FIG. 2, comprises a casing 1 contained therein an AC-drive single-phase induction motor (not shown), an output shaft 2 of the motor, gear trains 3 having a gear 4 connected to the output shaft 2, a ratchet wheel 5 having a claw 6, supported rotatably by the casing 1, and a coil spring 7 for urging the ratchet wheel 5 so that an end surface 6a of a tip end of the claw 6 is brought into contact with a tooth face 4a of the gear 4 facing a direction of reverse rotation so as to prevent the reverse rotation of the gear 4.

In the induction motor with the ratchet device according to the present invention, the forward rotation of the motor can be transmitted through the gear train 3 because the end surface 6a of the tip end of the claw 6 of the ratchet wheel 5 is moved away against the spring action of the spring 7 so as to be separated from the tooth face 4a of the gear 4 when the gear 4 is rotated in the forward direction of an arrow shown in FIG. 2, whereas the reverse rotation of the motor is not transmitted through the gear train 3 because the end surface 6a of the tip end of the claw 6 is brought into contact with the tooth face 4a of the gear 4 and the reverse rotation of the gear 4 is prevented.

In the other embodiment of the present invention, a contact angle formed by the end surface 6a of the tip end of the claw 6 and a center line of the tooth of the gear 4 contacting with the end surface 6a of the claw 6 is set equal to a pressure angle A of the gear 4.

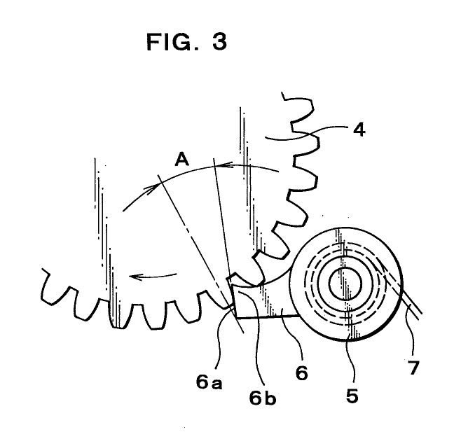

Further, an inside corner 6b of the end surface 6a of the tip end of the claw 6 is projected toward a tooth root of the gear 4 as shown in FIG. 3 so that the end surface 6a of the tip end of the claw 6 is not removed from the tooth face 4a of the gear 4 when the gear 4 is rotated reversely and that the reverse rotation of the gear is prevented surely.

A spring may be formed to the ratchet wheel 5 as a unit instead of the coil spring 7.

According to the present invention, the induction motor is use for the automatic ice making apparatus instead of the hysteresis motor, the motor can be formed small in size and the weight can be reduced from 160 grams to 80 grams, for example. Accordingly, the manufacturing cost, power consumption and the resources of the apparatus can be reduced.

While this invention has been described with specific embodiments thereof, it is evident that many alternatives, modifications, and variations will be apparent to those skilled in the art. Accordingly, the preferred embodiments of the invention as set forth herein are intended to be illustrative, not limiting. Various changes may be made without departing from the spirit and scope of the invention. The scope of the present invention should be defined by the terms of the claims appended hereto.

We claim:

1. An induction motor with a ratchet device comprising: an induction motor, a gear connected to an output shaft of the motor, a ratchet wheel having a claw for preventing the reverse rotation of the gear, and an urging device for urging the ratchet wheel so that an end surface of a tip end of the claw of the ratchet wheel is brought into contact with a tooth face facing a reverse rotary direction of the gear so as to prevent the reverse rotation of the gear.

2. The induction motor as claimed in claim 1, wherein a contact angle formed by the end surface of the tip end of the claw and a center line of a tooth of the gear contacting with the end surface of the tip end of the claw is set equal to a pressure angle of the gear.

3. The induction motor as claimed in claim 2, wherein an inside corner of the end surface of the tip end of the claw is projected toward a tooth root of the gear so that the end surface of the tip end of the claw is not removed from the tooth face of the gear when the gear is rotated reversely.

4. The induction motor as claimed in claim 1, wherein an inside corner of the end surface of the tip end of the claw is projected toward a tooth root of the gear so that the end surface of the tip end of the claw is not removed from the tooth face of the gear when the gear is rotated reversely.

5. An induction motor with a ratchet device comprising:
an induction motor having an output shaft;
a gear connected to the output shaft of the motor and having a tooth face facing a reverse rotary direction of the gear;
a ratchet wheel having a claw that prevents reverse rotation of the gear, the claw having a tip end having an end surface; and
an urging device that urges the ratchet wheel in a direction that brings the end surface of the tip end of the claw of the ratchet wheel into contact with the tooth face facing the reverse rotary direction of the gear so as to prevent the reverse rotation of the gear.

6. The induction motor as claimed in claim 5, wherein a contact angle formed by the end surface of the tip end of the claw and a center line of a tooth of the gear contacting with the end surface of the tip end of the claw is set equal to a pressure angle of the gear.

7. The induction motor as claimed in claim 6, wherein an inside corner of the end surface of the tip end of the claw is projected toward a tooth root of the gear so that the end surface of the tip end of the claw is not removed from the tooth face of the gear when the gear is rotated reversely.

8. The induction motor as claimed in claim 5, wherein an inside corner of the end surface of the tip end of the claw is projected toward a tooth root of the gear so that the end surface of the tip end of the claw is not removed from the tooth face of the gear when the gear is rotated reversely.
